(19) United States
(12) Patent Application Publication
(10) Pub. No.: US 2012/0185399 A1
(43) Pub. Date: Jul. 19, 2012

(54) AUTOMOTIVE REPAIR WARRANTY AND RECALL TRACKING

(75) Inventor: David Draper, San Juan Cpistrano, CA (US)

(73) Assignee: Autovation, Inc., San Juan Capistrano, CA (US)

(21) Appl. No.: 13/352,207

(22) Filed: Jan. 17, 2012

Related U.S. Application Data
(60) Provisional application No. 61/433,801, filed on Jan. 18, 2011.

(51) Int. Cl. G06Q 10/00

(52) U.S. Cl. 705/303

(57) ABSTRACT

Methods for notifying customers of vehicle recall notices are disclosed, including a passive method where vehicles brought to a service station are processed, and an active method where mailings are generated to vehicle owners. Based upon the provided vehicle identification number in a repair order or in a customer list, a manufacturer recall database is queried with a recall campaign retrieval request. Vehicle recall notices are transmitted and received in response, with some vehicles being subject to outstanding recall campaigns identified therein. One or more corrective maintenance services are associated with the vehicle recall notices. An alert notification or the mailings to the customers including the recall notification are generated.

### CROSS-REFERENCE TO RELATED APPLICATIONS

This application relates to and claims the benefit of U.S. Provisional Patent Application No. 61/433,801 filed Jan. 18, 2011 and entitled METHOD FOR TRACKING AUTOMOTIVE REPAIR AND WARRANTY SERVICES, the entire contents of which are incorporated herein by reference.

### STATEMENT RE: FEDERALLY SPONSORED RESEARCH/DEVELOPMENT

Not Applicable

### BACKGROUND

1. Technical Field

The present disclosure relates generally to information management in the automotive industry. More particularly, the present disclosure relates to systems and methods for automotive repair, warranty, and recall tracking.

2. Related Art

Automobiles permeate virtually every aspect of daily life in most developed countries except for the few major cities with robust public transportation systems, and are relied upon for going to and from work, school, shopping, leisure activities and countless other destinations. By some estimates, there are around 600 million automobiles in service worldwide, with various manufacturers producing a total of some 70 million units annually. Over its development history, automobiles have evolved from basic machines comprised of little more than wheels and a propulsion source on a frame to sophisticated systems with numerous features that improve safety, efficiency, driving experience, and passenger comfort.

Inherent in many technological advances is the increased risk of harm to its users. For instance, an increase in the power of the engine may have the benefit of a higher attainable speed such that drivers can reach the intended destination more quickly, but with such increases in speed, the risk of significant bodily injury in a crash is much greater. Partially to counter the heightened safety risk associated with higher speeds, improvements in braking systems have been developed, for example, as well as improvements in frame and body designs for absorbing impact shocks, improvements in restraint systems such as seatbelts and airbags, and so forth. This is but one example of the progression of the features of the automobile, and numerous other subsystems and components have been added and improved upon over time.

As the features in automobiles increase, however, its complexity grows along with an increase in the number of potential failure points, some of which can be catastrophic during operation. Furthermore, seemingly unrelated components can cause failures in other components, and this is particularly so because conventional automobiles employ electronics and computer systems for much of the functionality. Due to faulty or incomplete programming, data corruption from one set of inputs for one subsystem has the potential to propagate to other subsystems, affecting the overall reliability of the vehicle. In addition to the traditional mechanical issues that may affect safety and reliability, with modern automobiles there is an added challenge in attempting to identify problems that may surface sporadically only under specific environmental and operational conditions.

Any manufacturer of a product, including manufacturers of automobiles, performs extensive design reviews and testing at multiple organizational levels to ensure that defects are eliminated before the products are sold to the consumer. However, due to limited time and resources, some problems inevitably remain. As mentioned above, the likelihood of hidden issues increases with greater complexity and concomitant failure points as existing in modern automobiles. The problems may range from minor issues that have little to no effect on the safe operation, to major design defects that permeate the entirety of the vehicle.

The design of the particular automobile and/or its individual subcomponents may be sound, but problems may be rooted in the manufacturing process. Improvements in manufacturing are constantly sought throughout the product lifecycle for increases in efficiency, cost reduction, and environmental cleanliness, among other reasons. From time to time, different processes may be substituted, with some that introduce defects into the finished product. Accordingly, the hidden issues may arise only in certain product lots. In some cases where the failure lies in the entire manufacturing process, the entire production run may be plagued with the same issues.

Upon discovery of the defects, whether initially made by the manufacturer, by consumers, or by non-manufacturer service personnel, depending on its severity, the manufacturer may initiate a recall campaign. Product recalls are intended to limit liability for corporate negligence, as well as improve or prevent damage to the corporate image, and may be conducted voluntarily by the manufacturer. In some jurisdictions, recalls may be legally mandated, with failure to initiate a recall being grounds for substantial penalty assessments. Various correction options are available again depending on the severity of the problem, from product replacements, free repairs and/or parts, or outright refunds.

Running a recall campaign is expensive, largely due to the costs associated with replacements, repairs and parts. The management of the campaign and notifying affected customers is also expensive. Presently, recall notices are sent to applicable government agencies such as the Federal Trade Commission or the respective States' consumer protection offices. The notices specify which specific products are affected, as well as lot numbers and/or serial numbers thereof may be included, and are made available for viewing by the purchasing public. Further, specific notices to the affected customers may be sent by mailings addressed to the customers' last known addresses, or via phone calls if such information was collected by the manufacturer at the time of the initial purchase. Where the discovered problems are severe enough, they may be reported by the news media. For automobiles, because vehicles typically require periodic maintenance, recall notices may be posted for service managers and technicians for when the customer has such maintenance work performed.

Unfortunately, existing recall notification practices are deficient in many ways. To some extent, the manufacturer may be incentivized not to follow through on recall campaigns and do the minimum required under the law because of the aforementioned costs, so long as the problem is rarely encountered or not severe. Even when the defects result in catastrophic outcomes, manufacturers may simplify the problem to a cost-benefit analysis between the costs of the recall campaign and any possible settlement exposure based upon a quantified probability of such outcome materializing. The mailing information may be outdated, if it was even collected in the first place. Depending on the media to publicize the campaign is also problematic because most problems do not receive widespread and pervasive coverage, and like the mailings, may nevertheless be ignored. Posting the recall notices at repair and maintenance facilities depends on the diligence of individual service managers and technicians, who may often overlook them because of the large number and models of vehicles they handle, with each potentially being subject to multiple recall campaigns at any given time. Accordingly, there is a need in the art for an improved information management systems and methods for automotive repair, warranty, and recall tracking.

### BRIEF SUMMARY

The present disclosure contemplates various methods for notifying customers of vehicle recall notices, with one embodiment being directed to a passive notification system in which a vehicle brought to a service station is automatically checked for outstanding recall campaigns. This embodiment begins with a step of receiving a repair order with an associated vehicle identification number that may correspond to a specific one of the vehicles for which one or more such maintenance services are assigned. The repair order may include an itemization of the assigned maintenance services. The method may then continue with transmitting to a manufacturer recall database a recall campaign retrieval request. This request may include the unique vehicle identification number. Thereafter, the method continues with receiving one or more vehicle recall notices from the manufacturer recall database. The vehicle recall notices may be generated in response to the recall campaign retrieval request, and the specific one of the vehicles may also be subject to one or more outstanding recall campaigns as identified by the respective vehicle recall notices. One or more corrective maintenance services may be associated with the vehicle recall notices. The method may continue with generating an alert notification in response to an evaluated omission of the one or more corrective maintenance services from the assigned maintenance services that are itemized on the repair order.

Another embodiment is directed to generating mailing campaigns with recall notices from customer lists. The method may include receiving the customer list. Each customer listed therein may be associated with a unique product identifier and a set of customer contact data. The unique product identifier may correspond to a specific one of the products in possession by the specific one of the customers. Then, there may be a step of transmitting a recall campaign retrieval request to a manufacturer recall database. The recall campaign retrieval request may include the unique product identifier for at least one of the customers from the customer list. The method may further include receiving one or more recall notices from the manufacturer recall database. This data can be generated in response to the recall campaign retrieval request. The products may be subject to one or more outstanding recall campaigns as identified by the respective recall notices, each of which may be associated with one or more corrective actions. The method may further include storing the recall notices and the one or more corrective actions in a recall notification list. The customers may be identified by the respective sets of customer contact data. The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating the components of a data processing network for implementing the various methods of tracking recall notices and generating recall notifications in accordance with the present disclosure;

FIG. 2 is a table showing an example data structure for a repair order stored on a dealer management system;

FIG. 3 is a flowchart of one embodiment of the method of tracking recall notices;

FIGS. 4A and 4B are flowcharts of a series of preliminary operations that are a part of the method of tracking recall notices;

FIG. 5 is a screenshot of a user interface to a dealer management system showing the downloading of reports therefrom in accordance with various embodiments of the present disclosure;

FIG. 6 is a spreadsheet showing the various fields and corresponding sample values from the downloaded reports;

FIG. 7 is a screenshot of a manufacturer recall notice webpage;

FIG. 8 is an example recall campaign descriptor table;

FIG. 9 is an example recall campaign alert table;

FIG. 10 is a screenshot of another aspect of the user interface of the software application implementing the methods of tracking recall notices, particularly showing a linking to the dealer management system messaging functionality in generating alerts;

FIG. 11 is a flowchart of one embodiment of the method of generating recall notifications to customers;

FIG. 12 illustrates an example customer list data structure;

FIG. 13 is a flowchart showing the various post-processing operations performed on a customer recall alert list to prepare the same for a mailing; and

FIGS. 14A-14C show a table, in sections, of an example customer recall alert list generated in accordance with various embodiments of the present disclosure.

Common reference numerals are used throughout the drawings and the detailed description to indicate the same elements.

### DETAILED DESCRIPTION

The detailed description set forth below in connection with the appended drawings is intended as a description of certain embodiments of automotive repair warranty and recall tracking, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one entity from another without necessarily requiring or implying any actual such relationship or order between such entities.

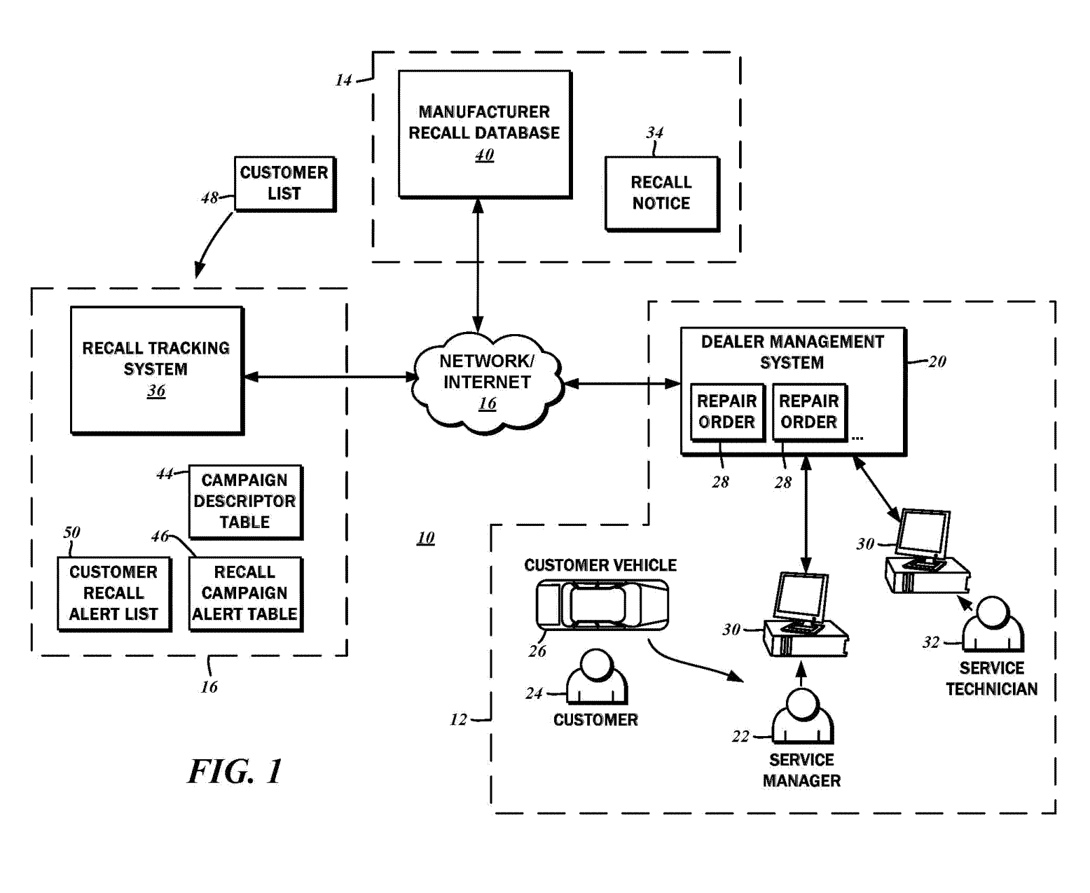

With reference to the block diagram of FIG. 1, an exemplary networked computing environment 10 in which various embodiments of automotive repair warranty and recall tracking may be implemented generally involves a dealer 12, a manufacturer 14, and a tracking provider 16, each of which are interconnected via a network 18. The present description is in the context of the automobile industry, where the independent dealer 12 purchases vehicles produced by the manufacturer 14 and sells them to the consumer public. As another source of revenue and for maintaining relationships with existing customers, the dealer 12 typically provides maintenance and repair services. Furthermore, the dealer 12 can serve in somewhat of a local representative capacity to the manufacturer 14 in order to fulfill warranty and recall work, as branding and marketing nominally associates the dealer 12 to the manufacturer 14.

The contemplated systems and methods may involve aspects that are specific to the automobile industry, and various features are described in relation thereto. It will be understood that the functional principles disclosed herein are also applicable to other markets and industries in which an independent dealer sells products on behalf of the manufacturer. Those having ordinary skill in the art will recognize the modifications to the various features disclosed herein pertinent to such alternative markets and industries.

In accordance with one embodiment of the present disclosure, the dealer 12 may have a dealer management system (DMS) 20 that handles various information management needs of the business. Such functions include vehicle inventory management and tracking, accounting, sales and employee commission tracking, customer financing calculations and document preparation, parts inventory management and tracking, repair or vehicle servicing management and tracking, and appointment scheduling, among many others. There are several dealer management systems 20 known in the art, and it is intended that embodiments of the present disclosure may be utilized in conjunction with any alternatives. Generally, the dealer management system 20 is comprised of a computer or data processing server that includes various software modules that implement the aforementioned functionality and are utilized by dealer staff to perform various tasks. For purposes of the present disclosure, since only the vehicle servicing management and tracking functionalities are utilized, the details of the dealer management system 20 will be limited thereto.

There may be a service manager 22 that handles customer intakes in a typical vehicle servicing department within the dealer 12. For instance, the service manager 22 may interact with a customer 24 in order to ascertain the desired maintenance and/or repair services for a vehicle 26. Based upon the information collected during the intake, the service manager 22 prepares a repair order 28 via an interactive computer terminal 30 connected to the dealer management system 20.

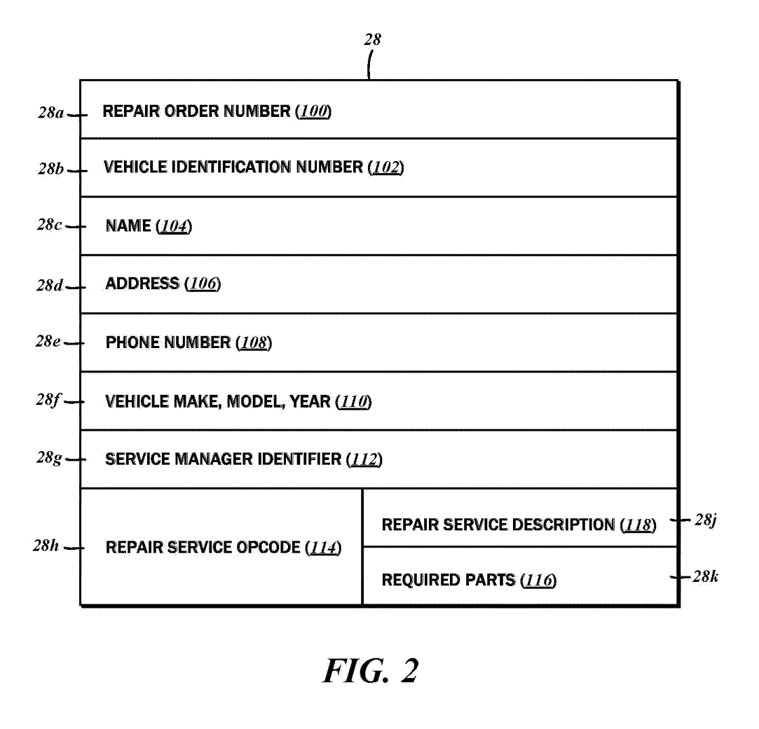

The table of FIG. 2 illustrates one exemplary embodiment of a data structure of the repair order 28. The specific repair order 28 is uniquely identified within the dealer management system 20 with a repair order number 100 stored in a repair order number field 28a. It is understood that each vehicle 26 is identified by a particular vehicle identification number (VIN) 102 stored in a VIN number field 28b, and is accordingly stored in the repair order 28. The specific customer 24 is identified by a customer name 104 in a name field 28c, a contact address 106 stored in an address field 28d, and a phone number 106 stored in a phone number field 28e. Other information about the customer 24 besides these may also be included in, or certain ones of those mentioned herein may be omitted from, the repair order 28. Although the vehicle make, model, and year can be identified from the vehicle identification number 102, such information 110 may also be reproduced within the repair order 28. A dealer service manager identifier 112 may be included in a field 28g. The selected repair services may be designated by an opcode 114 stored in a field 28h, along with identifiers 116 for the parts necessary therefor in a field 28i. Although the specific repairs are identified by the opcode 114, in some cases an associated descriptor 118 may also be incorporated and stored in a descriptor field 28j, to the extent additional information must be included beyond that provided by a generic system-wide descriptor provided by the dealer management system 20. It will be appreciated that any suitable form with relevant descriptors and input spaces may be displayed on the interactive computer terminal 30 to capture the information for the repair order 28. The inclusion or exclusion of certain items of data in the illustrated data structure of the repair order 28 are not intended to be limiting, and any other field may be utilized, and any of the fields shown may be eliminated, depending on particulars of the dealer management system 20.

Once the repair order 28 is generated, the vehicle 26 is passed to a service technician 32. The repair order 28 is accessed from the dealer management system 20 via the computer terminal, and the specified work is performed.

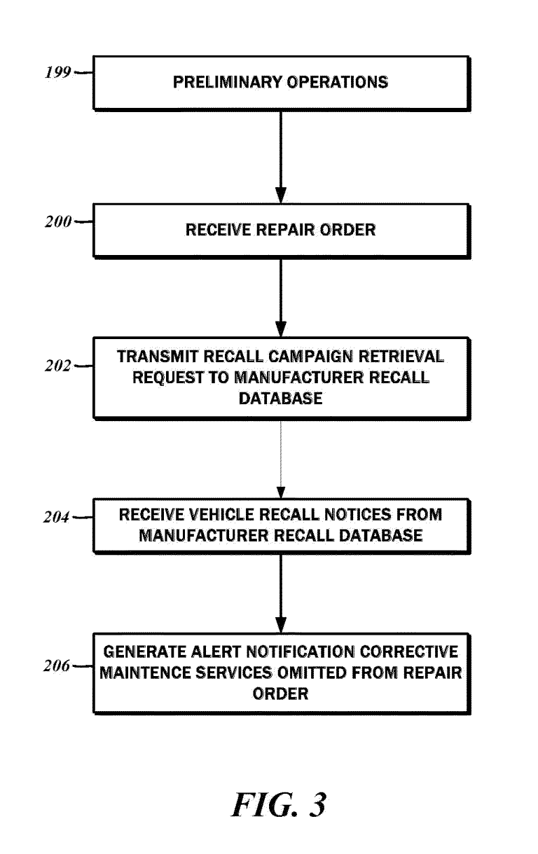

From time to time, the manufacturer 14 may become aware of certain problems with vehicles currently in service. Once a problem is detected and its resolution is finalized (necessary replacement parts, work required, etc.), the manufacturer 14 may issue recall notices 34 for specific vehicles or ranges of vehicles affected. Various embodiments of the present disclosure contemplate a way to timely notify the customer 24, the service manager 22 and/or the technician 32 to ensure that the necessary corrective work is performed, and one method for tracking the manufacturer recall notices 34 is described as follows with reference to the flowchart of FIG. 3.

Certain steps of the method are contemplated to be performed by a remote recall tracking system 36 that is managed by the tracking provider 16, which communicates with the dealer management system 20 over the network 18. In this regard, the network 18 may be public such as the Internet, or may also be a dedicated wide area network. Such implementation of the recall tracking system 36 that is remote from the dealer management system 20 is presented by way of example only and not of limitation. The following functions of the recall tracking system 36 may also be implemented at the site of the dealer 12, or even directly on the dealer management system 20. However, the remote arrangement may be more appropriate where the recall tracking system 36 is provided as a value-added third party service to the dealer 12 as well as other subscribing dealers.

The various steps of the method may be implemented as computer-executable instructions that are performed by the recall tracking system 36. Accordingly, the recall tracking system 36 may be a data processing apparatus or computer server that is capable of storing and executing those instructions based on certain parameters provided thereto as inputs, and generating certain outputs as results. Details pertaining to the specific hardware devices and operating system software utilized in the recall tracking system 36 are omitted, as those will be readily ascertained by those having ordinary skill in the art.

The method for tracking the manufacturer recall notices 34 may include a step 200 of receiving the repair order 28 from the dealer management system 20. As indicated above, the repair order 28 is tied to or associated with a particular vehicle identification number 102. Further, this vehicle identification number 102 corresponds to the specific one of the vehicles 26 for which one or more maintenance services is assigned. As also described above, the maintenance services are itemized in the repair order 28 by their respective opcodes 114.

The receipt of the repair order 28 is preceded by a series of preliminary operations 199 that results in the dealer management system 20 transmitting the repair order 28 to the recall tracking system 36 as an earlier counterpart step. Considering that the method may be implemented as a service to the dealer 12, the following steps discussed more fully below for tracking the manufacturer recall notices 34 are intended to be performed on more than just one repair order 28 stored on the dealer management system 20. At any given point in time, there may be multiple repair orders 28 being handled by the dealer 12, so multiple repair orders 28 can be processed in a single batch operation therefor. The preliminary operations 199 are understood to be housekeeping tasks for such batch operations.

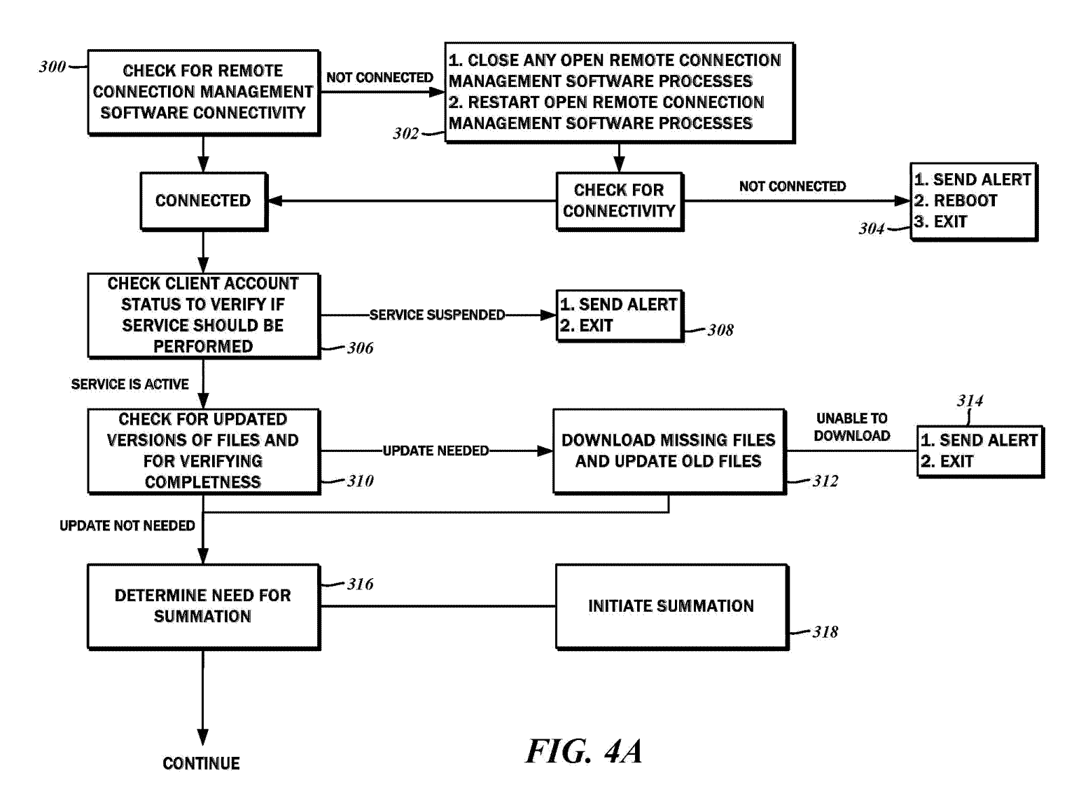

Additional details pertaining to the preliminary operations 199 will be described with reference to the flowchart of FIGS. 4A and 4B. These steps may be implemented as an executable program that is invoked by the operating system at predetermined intervals. In one embodiment of the present disclosure, this interval may be every twenty minutes, though it will be appreciated that any suitable interval may be utilized. In order to connect to the dealer management system 20, an external remote connection management software is utilized. In a step 300, the connectivity status thereof is confirmed. If no connection to the dealer management system exists, the program in a step 302 first closes any open instances of the remote connection management software, and restarts the same. If no connection can be established, in a step 304 an alert is transmitted to the system administrator of the recall tracking system 36, the system is restarted, and the program exits. However, if the connection can be established or if there was a connection already established before any of the foregoing actions, the program continues.

In the embodiment where the functionality of the program is provided to the dealer 12 as a service, the status of the subscription is confirmed. In a step 306, the program retrieves the account status associated with the particular dealer 12 to verify that payment for the services is current. If the account has been suspended then in step 308 get another alert is transmitted to the system administrator of the recall tracking system 36, and the program exits.

As will be described in further detail below, the program depends on updated data files and other executables; otherwise errors may occur and data may become corrupted. Upon confirming the subscription status of the dealer 12, there is a step 310 of checking the availability of updated versions of all files. This also confirms that the entire set of files necessary to the functioning of the program is available. If necessary, in step 312 the program downloads any missing files and updates outdated files. If the program is unable to so download the necessary files, in step 314 another alert is transmitted to the system administrator of the recall tracking system 36, and the program exits.

Various embodiments of the present disclosure contemplate the generating of alerts upon the discovery of the manufacturer recall notice 34. On a predetermined schedule, a summation of all discovered recall notices for a given time period is generated, and to the extent the program determines that any particular notice was not properly resolved with a customer 24, those are highlighted for review by the appropriate dealer staff. In step 316, the program determines whether that summation process has been completed on schedule, and if not, it is initiated in step 318.

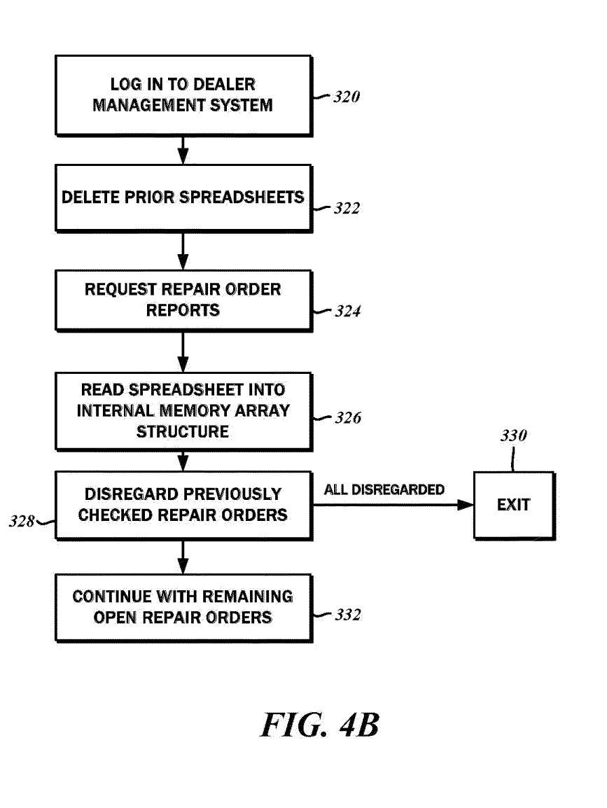

Referring particularly to the flowchart of FIG. 4B, the program continues with logging in to the dealer management system 20 according to step 320. In one exemplary embodiment, the recall tracking system 36 establishes a terminal emulator connection to the dealer management system 20. Via the terminal interface as shown in FIG. 5, the program is capable of executing various functions of the dealer management system 20 by providing inputs thereto programmatically in such a way as to simulate human interaction. The screenshot illustrates the report generating function, which is contemplated to return all of the repair orders 28 open on the dealer management system 20. Further detailed criteria of which open repair orders 28 to include in the report, as well as the sorting, and the fields from each repair order 28 to use, can be set. In the example shown, the repair order number 100, the vehicle identification number 102, service manager identifier 112, the name of the customer 104, and the repair service opcode 114 are set to be included. Before initiating the request for the report, pre-existing spreadsheets for earlier-run reports are deleted in a step 322. The program continues with initiating the request to the dealer management system 20 for the report according to the parameters set through the terminal interface in a step 324.

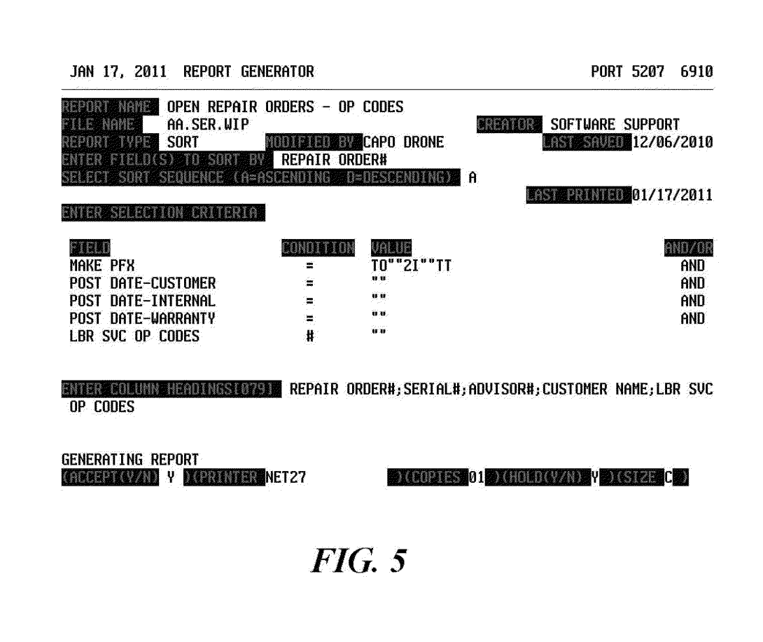

With reference to FIG. 6, a report of the open repair orders 28 on the dealer management system 20 are returned as a spreadsheet 38. Per the parameters described above, a first column 38a corresponds to the repair order number 100, a second column 38b corresponds to the vehicle identification number 102, a third column 38c corresponds to the service manager identifier, a fourth column 38d corresponds to the customer name 104, a fifth column 38e corresponds to the repair service opcode 114, and a sixth column 38f correspond to the repair service description 118. Each row thus corresponds to a particular repair order 28, though multiple repair service descriptions may be linked to a single repair order 28. Then, in step 326, the spreadsheet 38 is read into an array memory structure that is more readily manipulated. The recall tracking system 36 is understood to maintain a separate data file with repair orders 28 that have already been processed during an earlier batch processing run. To the extent the current report includes those repair orders 28, those are omitted from further processing in step 328. If all of the repair orders 28 are removed, then the program exits per step 330. The program continues with any remaining open repair orders 28.

It will be appreciated that certain of the above-described steps are particular to those embodiments in which the recall tracking system 36 is remote from the dealer management system 20. In alternative embodiments, the steps may not be necessary, or may be performed, but with some modification. Those having ordinary skill in the art will recognize any changes to the recall tracking system 36 to implement the same under a different environment.

Referring again to the flowchart of FIG. 3, the method for tracking manufacturer recall notices of vehicles continues with a step 202 of transmitting a recall campaign retrieval request to a manufacturer recall database 40 that stores the various manufacturer recall notices 34. As utilized herein, the manufacturer recall database 40 is understood to be any database that stores recall information, whether it be maintained by the manufacturer 14 or not. It is expressly contemplated that third parties may collect and manage the recall information from various manufacturers, and the method can include transmitting the recall campaign retrieval requests thereto. The recall campaign retrieval request is understood to include the particular vehicle identification number 102 for which the request pertains. In this regard, the following steps are understood to be performed for each of the vehicle identification numbers of the remaining open repair orders 28, though only a description of one iteration will be provided herein.

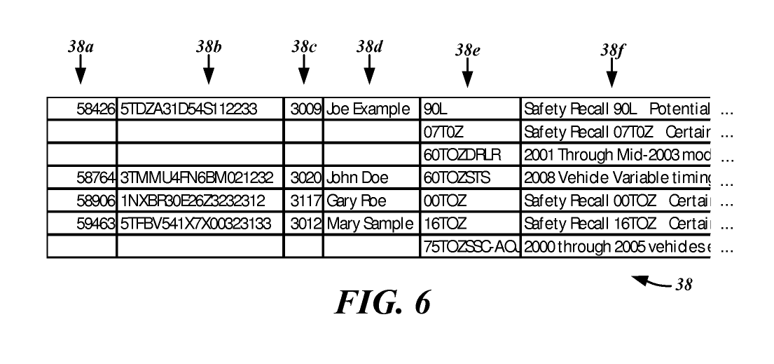

The manufacturer recall database 40 may have a variety of implementations, but considering its preferred, though optional connection to the recall tracking system 36 via the Internet 18, most likely it is a Web server to ensure maximum accessibility and compatibility. The manufacturer recall notices 34 are understood to be accessible only to select users such as the dealer 12, and so access to the manufacturer recall database 40 may be restricted with password-protected accounts. As a precursor to transmitting the recall campaign retrieval request in step 202, there may be a step of providing access credentials to the manufacturer recall database 40 and logging in. As will be recognized by those having ordinary skill in the art, interaction between a client and a Web server takes place over the hypertext transfer protocol (HTTP), and involves the transfer of various hypertext markup language (HTML) files that are transmitted from the Web server in response to a request from the client. In the context of the method for tracking manufacturer recall notices, the vehicle identification number 102 currently being processed by the recall tracking system 36 is first transmitted to the manufacturer recall database 40. Based upon a query for the provided vehicle identification number 102 that is transmitted through a HTML form element, a vehicle information webpage 42 may be generated and transmitted to the recall tracking system 36. An exemplary rendering of the vehicle information webpage 42 is shown in FIG. 7, but in order for the recall tracking system 36 to parse the data contained in the vehicle information webpage 42, it is not necessary to render it thus.

The method continues with a step 204 of receiving the manufacturer recall notices 34 from the manufacturer recall database 40. As referenced herein, the manufacturer recall notices 34 are understood to correspond to the aforementioned vehicle information webpage 42. The particular vehicle referenced in the manufacturer recall notice 34 is understood to be subject to one or more outstanding recall campaigns. An identification of the recall issue and the corrective maintenance services required therefor are included in the manufacturer recall notice 34.

The program makes certain assumptions about the various formatting conventions of the vehicle information webpage 42, as all other vehicle information webpages returned for different vehicle identification numbers is understood to be similarly arranged. By way of example only and not of limitation, one implementation of the vehicle information webpage 42 may surround the relevant contents with a <BODY> HTML tag. Within such <BODY> tag, there may be a series of <DIV> tags designating generic block-level elements. For the example vehicle information webpage 42, the fifty-first <DIV> tag is understood to include several <SPAN> elements, each which contains one data element. The third <SPAN> element may contain an identification of the vehicle model as correlated to the queried vehicle identification number, the fifth <SPAN> element may contain a vehicle year again as correlated to the queried vehicle identification number, the tenth <SPAN> elements may contain the date of first use, and the eleventh <SPAN> element may contain a line-off date, i.e., the date that particular vehicle came off the assembly line of the manufacturer 14. Subsequent <SPAN> elements could be a description 118 of the recall campaign, a status indicator, the date on which the service was performed, and the repair order number 100 under which the service was completed, in that order. These series of <SPAN> elements may then be read into an array for further processing, where the pertinent data describing the details of the outstanding recall campaigns are derived. Different data sets will be shown to describe the functionality and data derivation steps involved.

A first example array may be comprised thus as shown:

TABLE 1

| | |
|---|---|
| [0] | |
| [01] | Safety Recall A0A—Accelerator Pad |
| | Reinforcement Bar Installation |
| [02] | Completed |
| [03] | 08/28/11 |
| [04] | Dealership Company |
| [05] | 04362 |
| [06] | Safety Recall 90L—Potential Floor Mat |
| | Interference with Accelerator Pedal |
| [07] | Completed |
| [08] | 08/28/11 |
| [09] | Dealership Company |
| [10] | 04362 |
| [11] | Certain 2009-2010 Make Model Vehicles |
| | equipped with 2ZR-FE (1.8 Liter) Engines |
| | Brake System Vacuum Port |
| [12] | Completed |
| [13] | 08/28/11 |
| [14] | Dealership Company |
| [15] | 04362 |

Beginning with the last array element and proceeding in descending order, each array element (i.e., the data contained within a <SPAN> element in the vehicle information webpage 42) is checked whether it includes the terms “Not Completed.” In this example, there is no such array element, and so it is not necessary to proceed further.

A second example array may be comprised thus:

TABLE 2

| | |
|---|---|
| [0] | |
| [1] | Safety Recall B0M—Certain 2004 and 2005 |
| | Model Year Vehicles—1MZ-FE/3MZ-FE V6 |
| | Engine Cranks |
| [2] | Not Completed |
| [3] | Safety Recall B0A—Certain 2004-2006 |
| | model year vehicles Driver's Side Floor Carpet |
| | Cover and Retention Clip |
| [4] | Not Completed |
| [5] | Interim Safety Recall A0M—Certain 2005 |
| | through 2006 Model Year Vehicles Brake |
| | Master Cylinder Cup Replacement |
| [6] | Not Completed |

It is understood that not all sets of <SPAN> elements are arranged in the same order, and specific number or multiples of specific numbers cannot necessarily be assigned a specific field. In the examples above, whereas in Table 1, a set of five <SPAN> or array elements pertained to one recall campaign (a first element for a description, a second element for completion status, a third element for completion date, a fourth element for the servicing dealer, and a fifth element for the repair order number) in Table 2, only a set of two <SPAN> or array elements pertain to one recall campaign (a first element for a description, and a second element for completion status).

Continuing with the example of Table 2, once a “Not Completed” is found, the subsequent array element is checked whether it includes the terms “interim” or “Preliminary Notice.” If so, it is ignored, and proceeds with the subsequent array element. In the example above, array element [6] includes “Not Completed,” then array element [5] is found to include “Interim.” This is ignored, and continues with array element [4], which likewise includes “Not Completed.” Because the next array element [3] does not contain “interim” or “Preliminary Notice,” the contents thereof are stored for subsequent use. The conditions are the same for array elements [2] and [1], so the contents of array element [1] are stored for subsequent use.

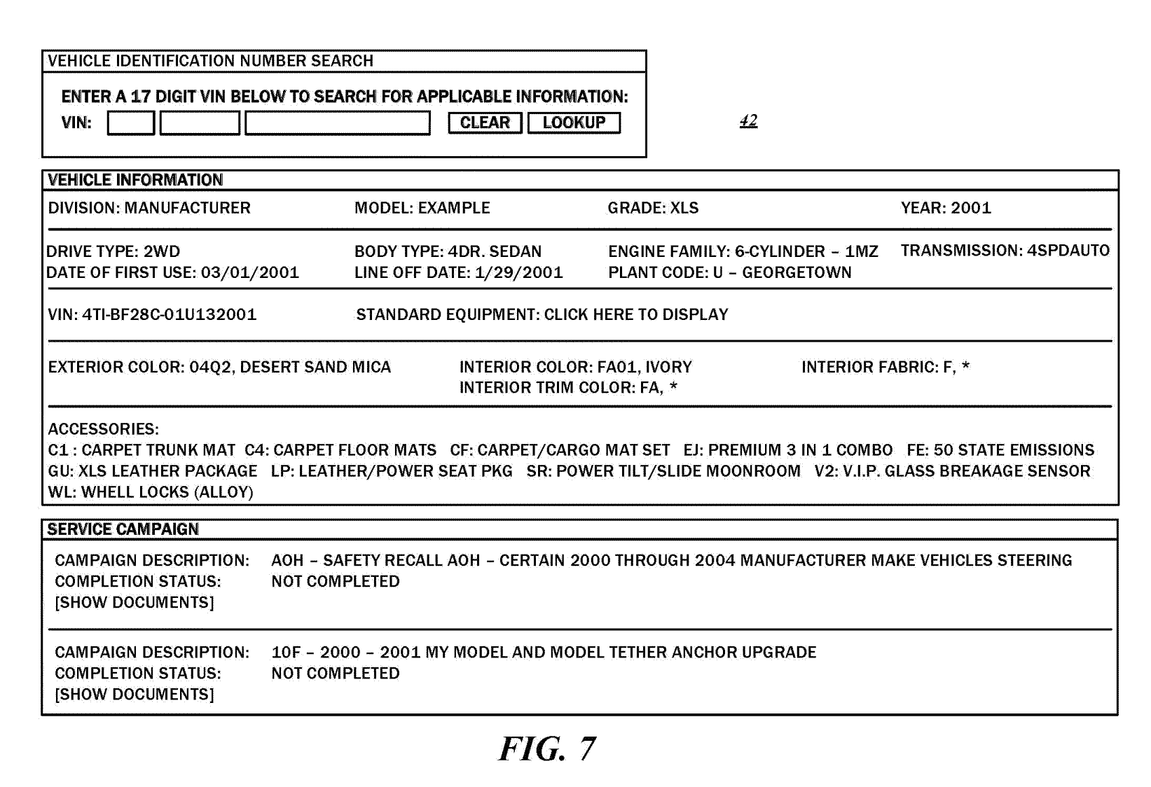

In one embodiment, the vehicle information webpage 42 does not include a more simplified descriptor or identifier such as a recall campaign code, and only the entire description of the recall campaign is provided. The recall tracking system 36 locally maintains a campaign descriptor table 44 as shown in FIG. 8 that associates recall campaign codes to descriptors. A search on the derived descriptor is conducted in the campaign descriptor table 44, and the corresponding recall campaign code is stored in the array. If a particular description is not found, the recall campaign code is indicated as N/A. The array shown in Table 2 now becomes Table 3:

TABLE 3

| | |
|---|---|
| [0] | |
| [1] | Interim Safety Recall A0M—Certain 2005 |
| | through 2006 Model Year Vehicles Brake |
| | Master Cylinder Cup Replacement |
| [2] | A0M |
| [3] | Safety Recall B0A—Certain 2004-2006 |
| | model year vehicles Driver's Side Floor Carpet |
| | Cover and Retention Clip |
| [4] | B0A |

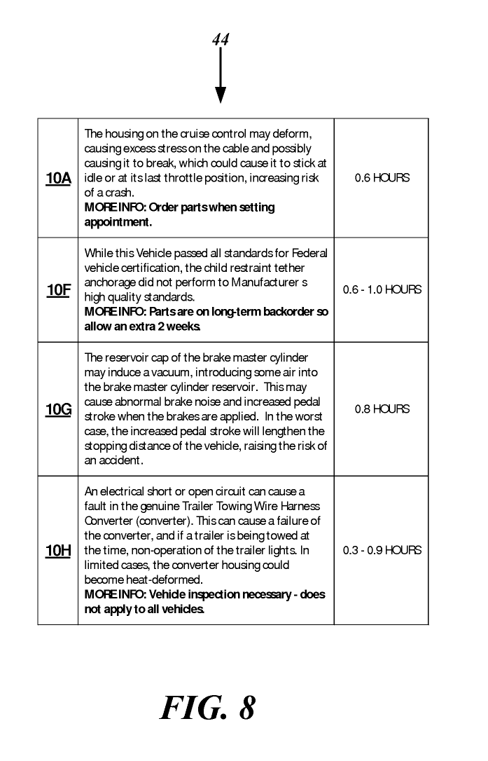

The data in the array, together with the associated repair order number 100, the vehicle identification number 102, and the dealer service manager identifier 112 for that particular recall campaign are stored in a recall campaign alert table 46. An example thereof is shown in FIG. 9; it will be recognized that the data contained in the illustrated example is not consistent with the data included in the tables above, as those were presented only for the purpose of simplifying the explanation of the operations involved with parsing the vehicle information webpage 42. Thereafter, the repair order number 100 is stored in the aforementioned data file that maintains duplicate or already processed repair orders 28 and associated repair order numbers 100.

It will be understood that the foregoing description of the parsing of the vehicle information webpage 42 is specific to its formatting, and have been presented as one example of possibly many. Different manufacturers 14 may format and present the same information differently, and modifications to the HTML elements that are searched and the content delineated thereby may likewise be expected. Further, even with the same formatting, there may be a variety of different ways in which to derive the aforementioned information from the vehicle information webpage 42. Those having ordinary skill in the art will readily ascertain those alternative modalities.

The recall campaign codes are understood to correspond to the repair service opcodes, and so the existing open repair orders 28 are checked to see if the returned repair campaign code(s) was/were already added thereto. For the embodiments where the entire description of the repair campaign is utilized, it is understood that this step encompasses the checking of such descriptions. If it had not been included, the method continues with a step 206 of generating an alert notification to the service manager 22 or any other dealership personnel that the particular corrective maintenance services have been omitted, and that some remedial action should be taken.

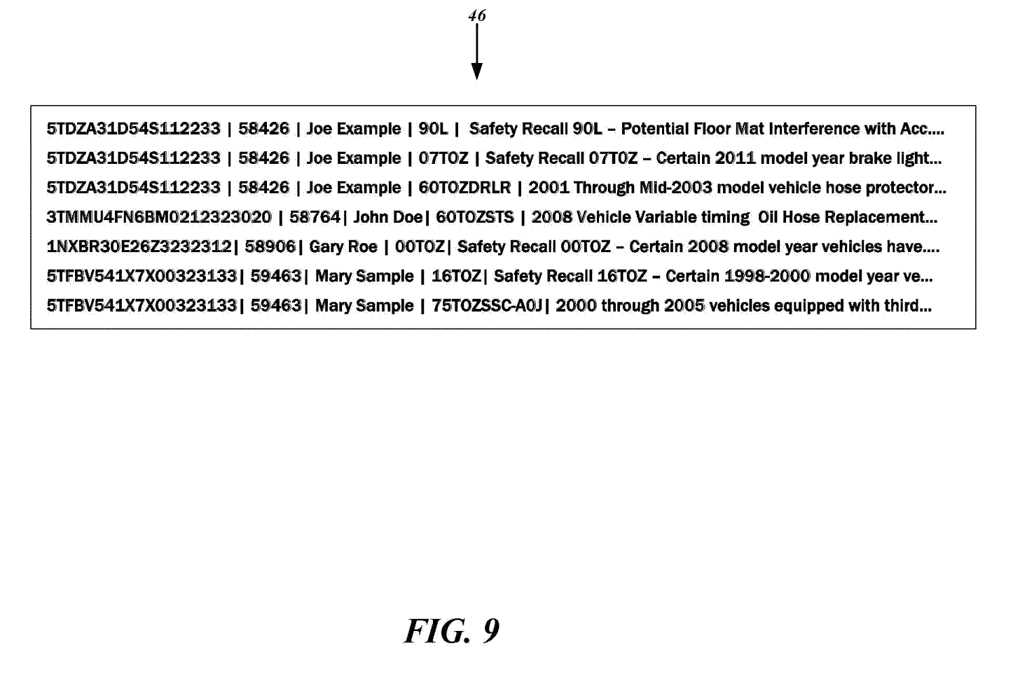

Referring to the screenshot of FIG. 10, the recall tracking system 36 directs the dealer management system 20 to generate a message thereon alerting the service manager 22 to the omitted corrective maintenance services that are specified as a part of the manufacturer recall notices 34. As shown, the repair order number 100, the vehicle identification number 102, the customer name 104, the vehicle make, model, and year 110, and the repair service opcodes 114 and accompanying descriptions 118 are included in the message. In addition, or as an alternative, the recall tracking system 36 may generate a standalone e-mail message delivered via the Internet 18. Where a standard e-mail message alert is transmitted, certain personally identifiable information may be removed to comply with privacy restrictions. More generally, however, the alert notification is understood to encompass any notification modality by which the dealer staff may be informed of recall campaigns that remain outstanding for a vehicle.

Other embodiments contemplate additional functions that may be invoked on the dealer management system. When omitted corrective maintenance services are detected, it may be automatically added to the repair order 28 in question without further input from the service manager 22. Alternatively, the service manager 22 can be prompted whether or not to revise the repair order 28. In many cases, the service manager 22 will provide a first set of instruction inputs via the terminal 30 to add the omitted corrective maintenance services. In some circumstances, however, it may be necessary to postpone the service, as the customer 24 may not have the time, the needed parts are unavailable, the parts and repair procedures have not yet been finalized by the manufacturer 14, and so forth. When the repair order 28 is not revised to include the corrective maintenance services, these stated reasons can be added. The stated reason, along with an identification of which corrective maintenance services were refused or postponed, can be logged for future auditing/performance reviews. Along these lines, the printed repair order 28 provided to the customer 24 may include a disclaimer when corrective maintenance services are refused or postponed.

While the above description of the method for tracking the manufacturer recall notices 34 utilizes the repair order 28 as a conduit between the dealer 12, the manufacturer 14, and the tracking provider 16, it will be recognized that other embodiments need not be limited thereto. For example, an appointment scheduling system for the service department, to the extent that a vehicle identification number is utilized, can also search for outstanding manufacturer recall notices 34 and schedule the corrective maintenance services in the same manner discussed above.

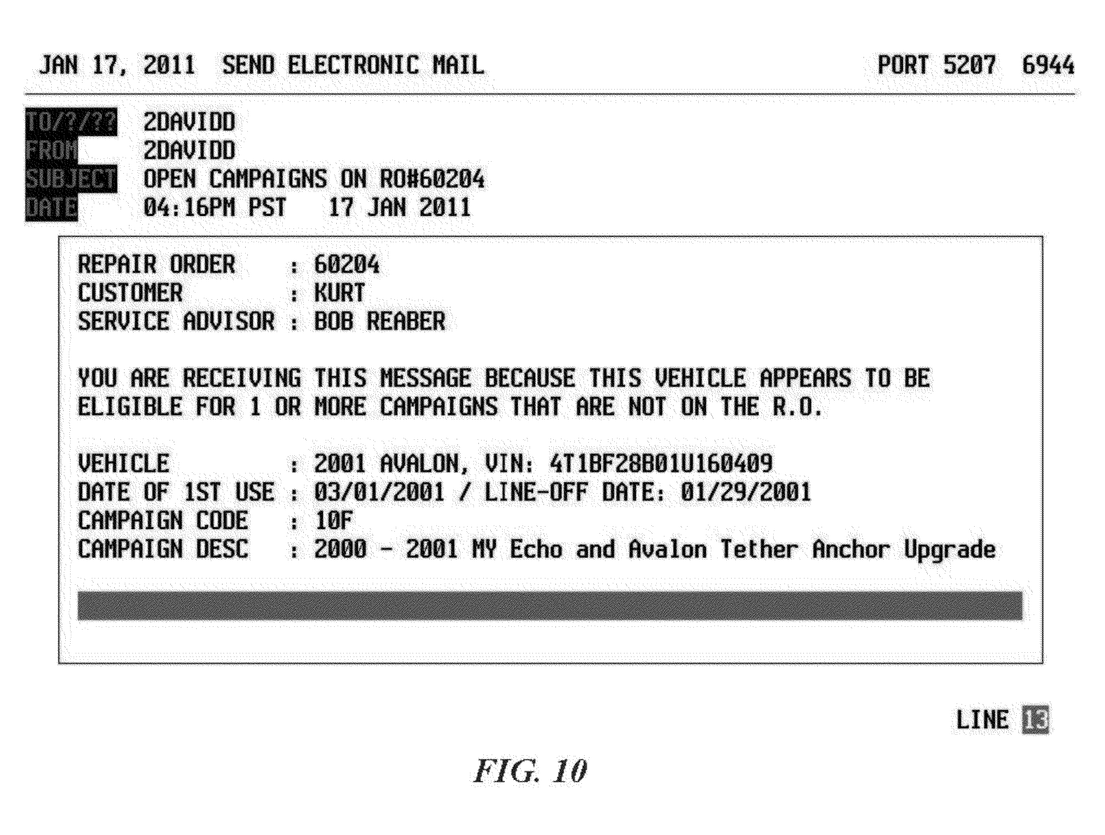

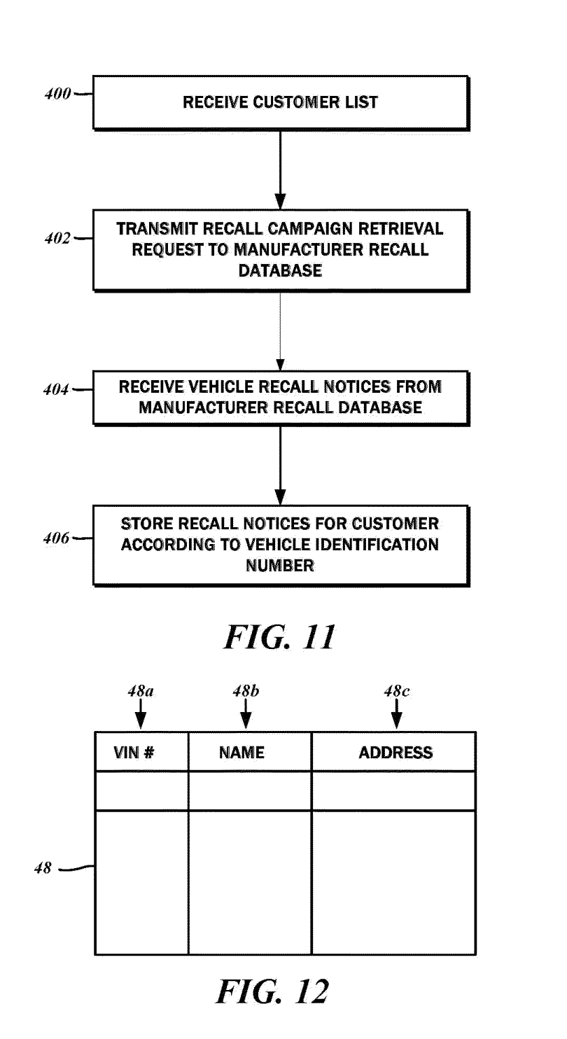

Referring now to the flowchart of FIG. 11, the present disclosure envisions a method for generating notifications of recalls of products to the customers 24. Again, the description will be in the context of vehicles that are particularly identified by a vehicle identification number, though it will be appreciated that any other types of products may be handled in accordance with the contemplated method. Generally, this method is directed to utilizing the above-described technique of discovering outstanding recall campaigns from the manufacturer recall database 40 in order to proactively notify potential customers 24 that may not yet had any contact with the dealer 12 with informative mailings. The method begins with a step 400 of receiving a customer list 48, an exemplary data structure of which is shown in FIG. 12. There is understood to be a vehicle identification number field 48a for storing the vehicle identification number 102, a customer name field 48b for storing the customer name 100, and a customer mailing address field 48c for storing the customer address 106. The particular make, model, and year to which the vehicle identification number pertains may also be included in separate fields, though in some embodiments this data is derived from the vehicle identification number 102 and are not reproduced. The customer list 48 may be provided by the manufacturer 14 and includes owners of vehicles specified by the vehicle identification numbers 102 who are located within a predetermined distance of the dealer 12.

The customer list 48 and more specifically, the vehicle identification numbers 102 therein, are used to download information on outstanding recall campaigns from the manufacturer recall database 40 utilizing the techniques discussed above. This includes a step 402 of transmitting a recall campaign retrieval request to the manufacturer recall database 40. In response to this request, the manufacturer recall database 40 transmits the manufacturer recall notices 34 as set forth in the submitted vehicle identification number 102. The manufacturer recall notices 34 may also include one or more corrective actions that address the recall campaign indicated therein. The recall tracking system 36 continues with a step 404 of receiving such manufacturer recall notices 34. These two steps are understood to correspond to the aforementioned steps 202 and 204, and the details discussed in relation thereto, including the parsing of the vehicle information webpage 42, are understood to be applicable here.

In accordance with step 406, the received manufacturer recall notices 34 are then stored in a customer recall alert list 50, which is understood to be comprised of the data from the customer list 48 merged with the manufacturer recall notices 34. Since the customer list 48 is indexed with the vehicle identification number 102, so is the customer recall alert list 50. This list may be similar to the recall campaign alert table 46 mentioned above, but additionally including the customer address 106, as mailings are generated therefrom.

The method can be implemented as a service provided by the tracking provider 16 to the dealer 12, prior to receiving the customer list, after receiving the customer recall alert list 50, or anytime between, several housekeeping type tasks may be performed by an executable application running on the recall tracking system 36. One contemplated embodiment charges the dealer 12 for the number of mailings generated, and the verification of payment for the particular number of mailings requested may be made. Furthermore, the manufacturer 14 may issue some recall notices for certain climate regions, while not for others. It will be recognized that manufacturers 14 often divide dealerships into two segments—“cold weather” and “warm weather.” Because which specific recalls will be honored by the manufacturer 14 depends on the status of the dealer 12, a determination thereof is made. Where the service is configured to handle multiple manufacturers 14, the particular make of the vehicles for which the notices are generated is also confirmed. The dealer 12 has the option to set the monetary value of the recommended corrective maintenance services so as to make the best use of the mailings, which can be expensive depending on the delivery modality used. The campaign descriptor table 42 mentioned above is read into an array for easier manipulation. If the dealer 12 has prepared mailings previously with the service, a newly generated customer recall alert list 50 is merged with the earlier version. The order in which the steps are performed is not critical.

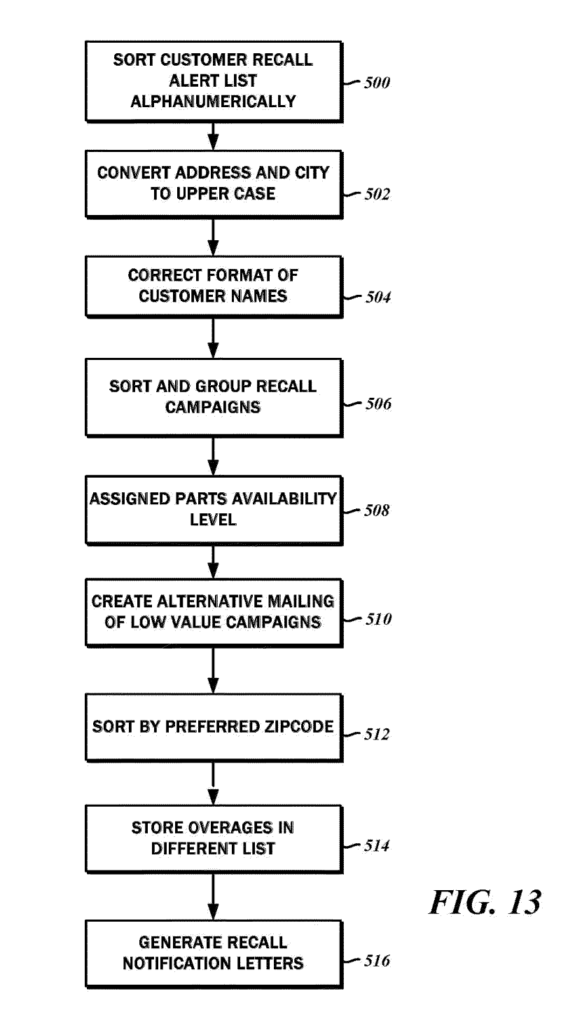

Now, with reference to the flowchart of FIG. 13, the details of the additional post-processing applied to the customer recall alert list 50 to prepare for the mailings to the customers 24 will be considered. The customer recall alert list 50 is sorted in alpha-numeric order in step 500, and read into another array for easier manipulation. Thereafter, the customer addresses are converted to uppercase in a step 501.

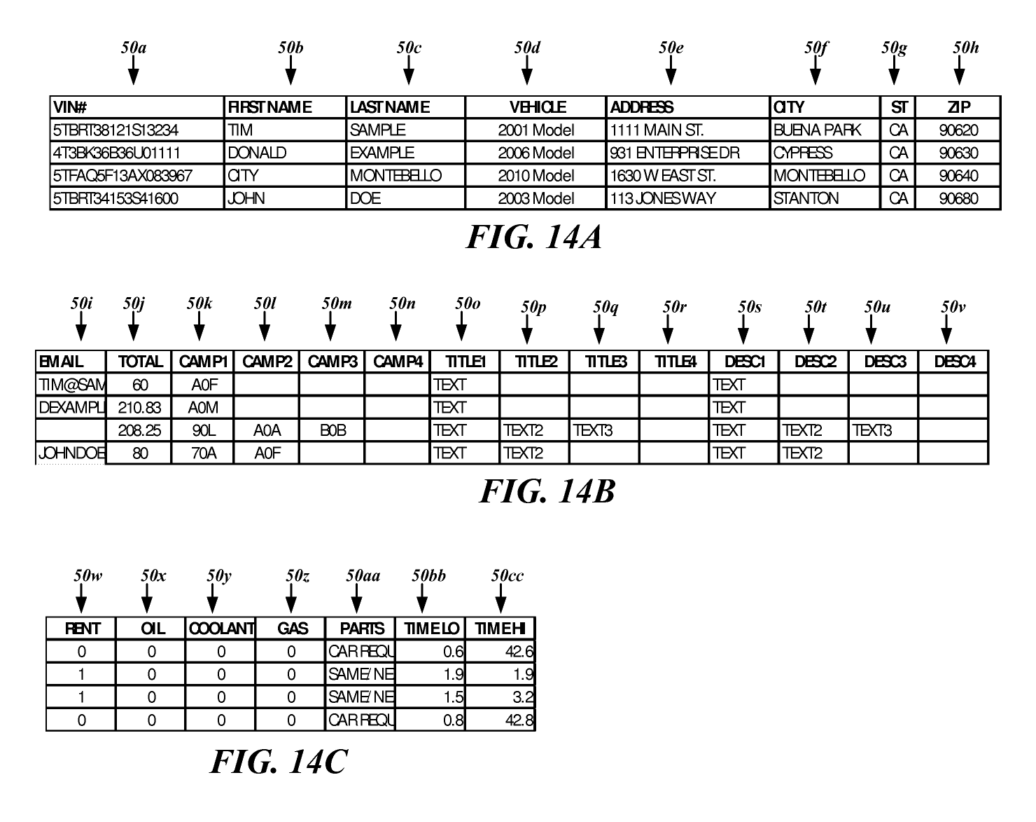

An example customer recall alert list 50 is shown in FIG. 14, and data elements for a given vehicle identification number 102 are each stored in a separate column. A first column 50a includes the various vehicle identification numbers 102, a second column 50b includes the first names of the customers 24, and a third column 50c includes the last names of the customers 24. A fourth column 50d includes the year and model of the vehicles corresponding to the vehicle identification number 102. A fifth column 50e includes the mailing address, a sixth column 50f includes the mailing address city, a seventh column 50g includes the mailing address state, and an eighth column 50h includes the mailing address zip code. As another means of contacting the customer 24, there is ninth column 50i for the e-mail address of the customer 24.

It is presently contemplated that the recall tracking system 36 is capable of handling up to four recall campaigns simultaneously for a given vehicle identification number 102. This limit is by way of example only and not of limitation, and the method may be modified to simultaneously accommodate more or less recall campaigns. Each of the recall campaigns have an associated cost estimate, and a tenth column 50j includes a monetary sum of each of the recall campaigns. Eleventh through fourteenth columns 50k-50n includes the respective repair service opcodes 114, while fifteenth through eighteenth columns 50o-50r includes the titles of the recall notices associated therewith. Similarly, nineteenth through twenty second columns 50s-50v includes a more detailed description of the recall notices that more fully explain the necessary work and the potential hazards. A twenty third column 50w defines whether any of the recommended maintenance services would require a car rental due to the extensive time needed for completion. A twenty fourth column 50x indicates whether an oil change is included, a twenty fifth column 50y indicates whether an engine coolant change is included, and a twenty sixth column 50y indicates whether fuel is to be topped off. The level of availability of parts necessary to complete the maintenance service are included in a twenty seventh column 50aa. The labor required to complete the maintenance service can be characterized by a low time estimate, included in a twenty eighth column 50bb, and a high time estimate, included in a twenty ninth column 50cc. This additional data is understood to be derived from the aforementioned campaign descriptor table 42.

Following step 502, the format of the customer names in the customer recall alert list 50 are corrected in a step 504. This includes analyzing the first and last names to determine whether any should be combined into a single last name, such as the case when the customer is a corporate entity. The first name and the last name are matched against a flag list including such words as “Company,” “Institution,” “Inc.” and so forth. Those having ordinary skill in the art will recognize other such words that are suitable for combining. Where those words are found in the last name, then the corresponding first name, which may be the unique name of the company, is merged with the last name. For example, with “ABC” as a first name, and “Company” as a last name, the last name is modified to be “ABC Company” and the first name is left blank. This combination process is also employed where an ampersand character (&) is in the last name column 50c. Where there is no customer name indicated, a default text of “OWNER” is added to the last name column 50c, and the name of the vehicle is added to the first name column 50b. The clean-up process also removes all trailing and leading spaces, not only from the name columns 50b-50c, but the other columns as well.

After correcting the formatting of the customer names, the customer recall alert list 50 is sorted and grouped in accordance with a step 506. This step more particularly involves searching for rows having certain values in the tenth column 50j, the monetary sum of the recall campaigns. In some cases, the tenth column 50j may indicate “not yet available,” meaning that while the campaign is expected to take place and be honored by the manufacturer 14 in the future that time has not yet come. In other cases, the tenth column 50j may indicate “Delete,” meaning that the recall campaign has expired, is no long applicable, or the customer 24 otherwise does not need to be notified thereof. These rows are subsequently removed from the customer recall alert list 50 from which the mailings are generated. In some embodiments, however, where the customer recall alert list 50 is a conventional spreadsheet file, the values in those selected rows are copied to a different sheet within the same spreadsheet file. It is understood that where there are multiple recall campaigns, any one of the cost estimates for a specific recall campaign may indicate “not yet available.” In this case, all of the outstanding recall campaigns are flagged as unavailable, and removed from the customer recall alert list 50. Those having ordinary skill in the art will be able to develop alternative logic for handling different scenarios. For example, it may also be possible to remove just the unavailable recall campaigns, while retaining those recall campaigns that are active.

Next, in step 508, the availability of parts necessary for the corrective maintenance services are assigned for each vehicle identification number 102 in the customer recall alert list 50. Prior to this step, the titles and descriptors of the recall campaigns may have been retrieved for populating the appropriate fields in the customer recall alert list 50, based upon the specified opcodes 114. The level of parts availability may be one of six: at the first level, no parts are needed; at the second level, additional parts are needed, but are in stock or are readily available within a day or two; at the third level, the needed parts are expected within one week; at the fourth level, the needed parts are expected within two weeks; at the fifth level, the needed parts are fluctuating in availability, (sometimes taking just one day to return to stock, or multiple weeks in the worst case); and at the sixth level, the car is required to be brought to the dealer 12, meaning that an inspection is necessary in order to determine which parts are needed. In cases of multiple recall campaigns, the highest of the levels, i.e., the worst case scenario, is indicated. For example, if one recall campaign has a level two availability (parts expected within a day), while another recall campaign has a level six availability (car needed), then the field 50aa will indicate “Car Needed.”

Based upon the total values of the recall campaigns calculated and stored in the tenth column 50j of the customer recall alert list 50, low value campaigns are moved to a separate list or spreadsheet in a step 510. The threshold for what constitutes a “low value” is determined by the dealer 12, and as indicated above, is inputted at the initial stages of the method. With some campaigns, the value may be significantly high if the campaign is deemed applicable to the vehicle after an inspection is conducted. For purposes of calculating the value of the recall campaign, such conditional amounts may be ignored. However, under such circumstances, a notification of that campaign is still provided to the customer 24, so long as the other affected campaigns exceed the threshold.

In a step 512, the customer recall alert list 50 is sorted in accordance with the preferred zip codes, as the dealer 12 may desire to target certain locales over others based on general demographics and the like. Up to ten preferred zipcodes may be specified, though this example is arbitrary and is not intended to be limiting.

With one embodiment being a subscription-based service that is paid for on a per mailing basis, the number of rows/vehicle identification numbers 102 in the customer recall alert list 50 may exceed the amount for which the tracking provider system has been paid. These overages may be stored in yet another separate list or spreadsheet in step 514, to be handled at another time upon additional payment.

The method continues with a step 516 in which letters addressed to the customers 24 using the mailing address stored in the customer recall alert list 50 are generated. In each letter, the details of the recall campaign(s) as also set forth in the title and description stored in the customer recall alert list 50 are included, emphasizing the importance of having the work performed. Furthermore, an offer to perform complimentary services such as multi-point vehicle inspections and other perks may be incorporated into the letter. As an alternative contact modality, the customers 24 may be contacted via telephone by service personnel referring to the information in the customer recall alert list 50. Along these lines, the customer recall alert list 50 may be transmitted to the service manager 22 via e-mail or other modalities.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for tracking manufacturer recall notices of vehicles, the method comprising:
receiving a repair order with an associated vehicle identification number corresponding to a specific one of the vehicles for which one or more maintenance services are assigned, and an itemization of the assigned maintenance services;
transmitting to a manufacturer recall database a recall campaign retrieval request including the unique vehicle identification number;
receiving one or more vehicle recall notices from the manufacturer recall database generated in response to the recall campaign retrieval request, the specific one of the vehicles being subject to one or more outstanding recall campaigns as identified by the respective vehicle recall notices, one or more corrective maintenance services being associated with the vehicle recall notices; and
generating an alert notification in response to an evaluated omission of the one or more corrective maintenance services from the assigned maintenance services itemized on the repair order.

2. The method of claim 1, further comprising:
adding the one or more corrective maintenance services to the repair order.

3. The method of claim 1, wherein the alert notification includes an itemization of the corrective maintenance services associated with each of the one or more outstanding recall campaigns.

4. The method of claim 3, further comprising:
receiving a first set of instruction inputs to add the corrective maintenance services to the repair order.

5. The method of claim 3, further comprising:
receiving a second set of instruction inputs to skip adding the corrective maintenance services to the repair order.

6. The method of claim 5, further comprising:
receiving opt-out reasons for at least one of the corrective maintenance services omitted from the repair order;
storing the opt-out reason in a report database in association with the repair order and the vehicle identification number.

7. The method of claim 1, wherein the repair order is generated and stored on a remote dealer management system.

8. The method of claim 7, wherein the repair order is received in response to a remote query therefor, the repair order being one of a plurality of repair orders stored on the remote dealer management system.

9. The method of claim 8, wherein the remote query is for retrieving each of the plurality of open repair orders stored on the remote dealer management system.

10. The method of claim 9, wherein the remote query is initiated on a periodic basis.

11. The method of claim 7, wherein the corrective maintenance services are represented by opcodes.

12. The method of claim 7, wherein the alert notification is a message generated through the dealer management system.

13. The method of claim 7, wherein the alert notification is an e-mail message.

14. A method for generating notifications of recalls of products to customers, the method comprising:
receiving a customer list, each customer listed therein being associated with a unique product identifier and a set of customer contact data, the unique product identifier corresponding to a specific one of the products in possession by the specific one of the customers;
transmitting to a manufacturer recall database a recall campaign retrieval request including the unique product identifier for at least one of the customers from the customer list;
receiving one or more recall notices from the manufacturer recall database generated in response to the recall campaign retrieval request, the products being subject to one or more outstanding recall campaigns as identified by the respective recall notices and having associated therewith one or more corrective actions; and
storing in a recall notification list the recall notices and the one or more corrective actions for each of the customers for which the recall campaign retrieval request was transmitted, the customers being identified by the respective sets of customer contact data.

15. The method of claim 14, further comprising:
grouping the recall notices according to the customers by the unique product identifier.

16. The method of claim 14, wherein:
the product is a vehicle; and
the unique product identifier is a vehicle identification number (VIN).

17. The method of claim 14, further comprising:
generating contacts to at least one of the customers stored in the recall notification list from the associated set of customer contact data.

18. The method of claim 17, wherein the contact is a mailing including the recall notices and the one or more corrective actions.

19. The method of claim 17, wherein the contact is an e-mail including the recall notices and the one or more corrective actions.

20. The method of claim 17, wherein the contact is a telephone call describing the recall notices and the one or more corrective actions.

21. The method of claim 14, wherein the recall notification list is the customer list merged with the recall notices and the one or more corrective actions.

22. A non-transitory computer readable medium having computer-executable instructions for performing a method for tracking manufacturer recall notices of vehicles, the method comprising:
receiving a repair order with an associated vehicle identification number corresponding to a specific one of the vehicles for which one or more maintenance services are assigned, and an itemization of the assigned maintenance services;
transmitting to a manufacturer recall database a recall campaign retrieval request including the unique vehicle identification number;
receiving one or more vehicle recall notices from the manufacturer recall database generated in response to the recall campaign retrieval request, the specific one of the vehicles being subject to one or more outstanding recall campaigns as identified by the respective vehicle recall notices and having associated therewith one or more corrective maintenance services; and
generating an alert notification in response to an evaluated omission of the one or more corrective maintenance services from the assigned maintenance services itemized on the repair order.
